(19) United States
(12) Patent Application Publication
(10) Pub. No.: US 2014/0022511 A1
(43) Pub. Date: Jan. 23, 2014

(54) FRONT-PROJECTION GLASSES-FREE, CONTINUOUS 3D DISPLAY

(71) Applicants: Huei Pei Kuo, Cupertino, CA (US); Larry M. Hubby, Palo Alto, CA (US)

(72) Inventors: Huei Pei Kuo, Cupertino, CA (US); Larry M. Hubby, Palo Alto, CA (US)

(21) Appl. No.: 14/001,471

(22) PCT Filed: Feb. 28, 2011
(86) PCT No.: PCT/US11/26554

§ 371 Date: Oct. 8, 2013

(51) Int. Cl. G02B 27/22; G03B 21/60

(52) U.S. Cl. CPC G02B 27/225; G03B 21/60
USPC 353/10; 359/459; 29/428

(57) ABSTRACT

A light field display for generating glasses-free, continuous 3D images is provided. The light field display has a horizontal retro-reflective display screen with a microstructured surface having an array of narrowly-spaced, ninety-degree microstructures, and a vertical diffuser having an array of narrowly-spaced, randomly-patterned microstructures. The vertical diffuser is joined to the horizontal retro-reflective display screen to form a light field display for use in front-projection display systems.

### BACKGROUND

Light field displays have emerged to provide viewers a more accurate visual reproduction of three-dimensional (“3D”) real-world scenes without the need for specialized viewing glasses. Such displays emulate a light field, which represents the amount of light traveling in every direction through every point in space. The goal is to enable multiple viewers to simultaneously experience a true 3D stereoscopic effect from multiple viewpoints, by capturing a light field passing through a physical surface and emitting the same light field through a reflective display screen. Doing so has the potential to revolutionize many applications in areas as diverse as entertainment, business, medicine, and art, among others.

Light field displays often operate in conjunction with am array of projectors to display the light fields onto a display screen. The projectors may be placed in the front or in the back of the screen and need to be calibrated and aligned to ensure that the displayed images are consistent (e.g., same intensity). Both currently-available front- or rear-projection displays are plagued with distortions introduced by the display screen, such as Moiré patterns, ghosting, banding, depth distortions, and keystone distortions, among others. Designing a light field display to reduce or eliminate these distortions is therefore paramount to achieving a true, high quality 3D experience to viewers.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates an example of a horizontal retro-reflective display screen for use with a front-projection display system;

FIG. 2 illustrates an example reflection pattern of light incident into the horizontal retro-reflective display screen of FIG. 1;

FIG. 3 illustrates an example of a vertical diffuser for use with the horizontal retro-reflective display screen of FIG. 1;

FIG. 4 illustrates an example light field display using the horizontal retro-reflective display screen of FIG. 1 and the vertical diffuser of FIG. 3;

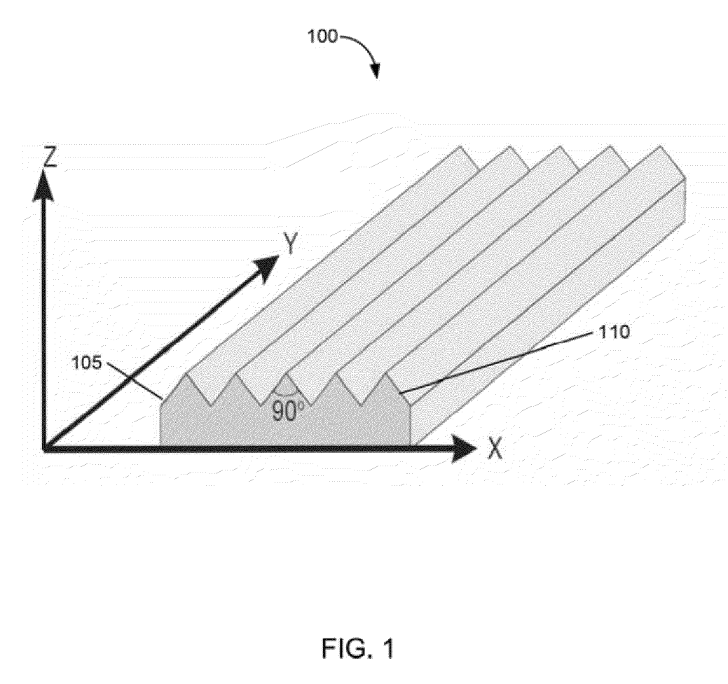

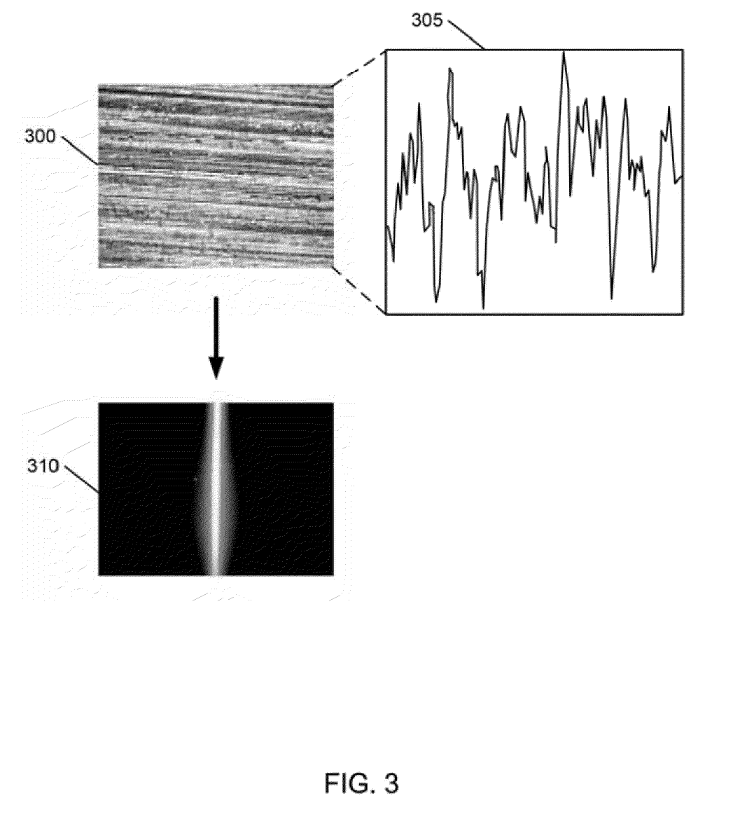

FIG. 3 illustrates another example of a light display using the horizontal retro-reflective display screen of FIG. 1 and the vertical diffuser of FIG. 3;

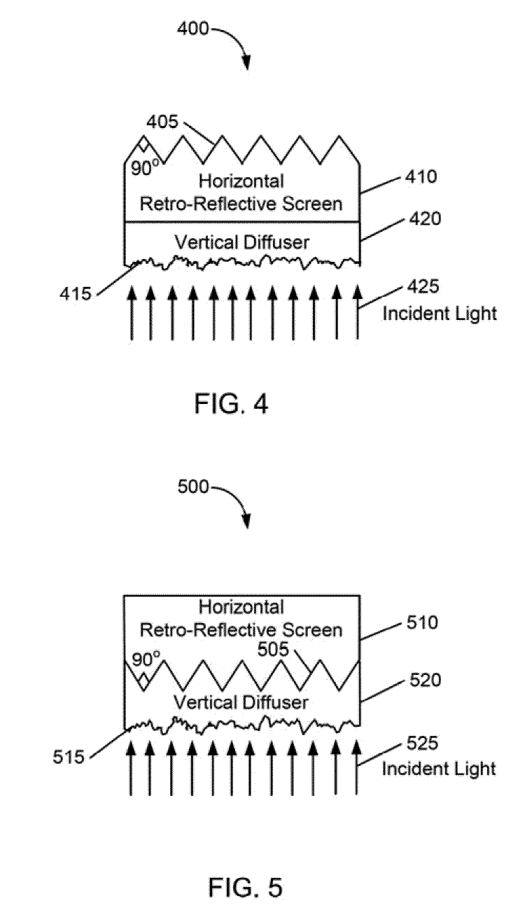

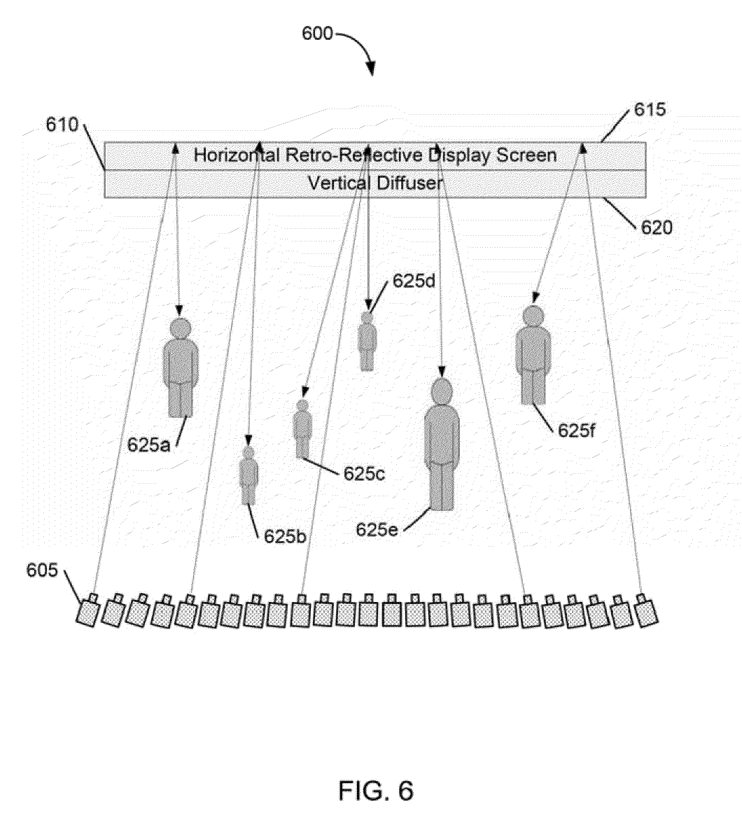

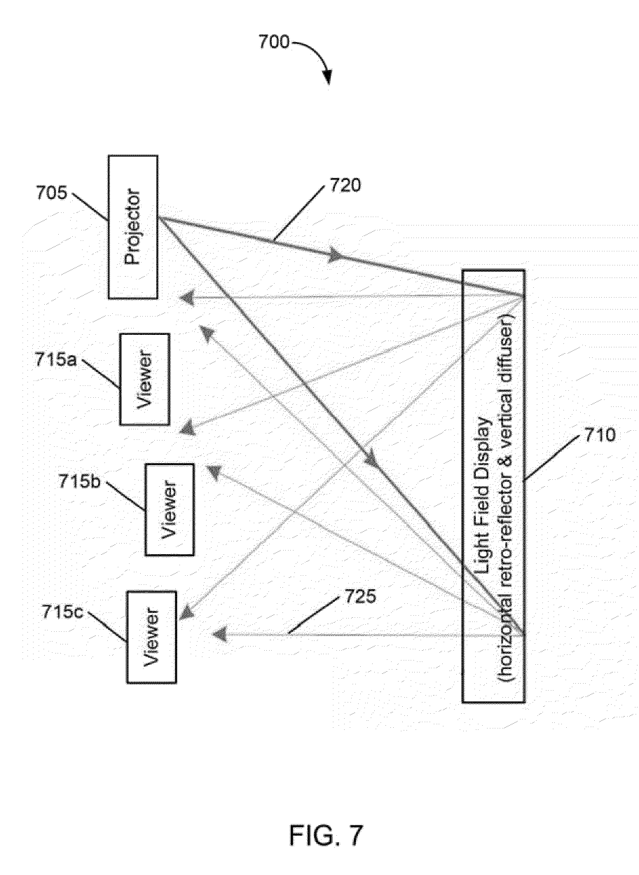

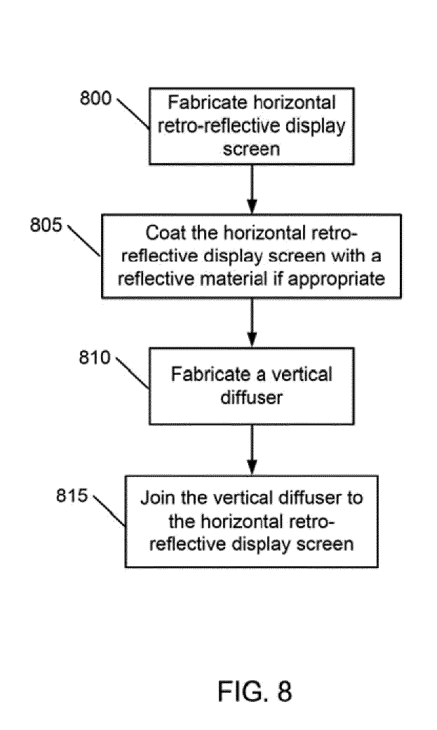

FIG. 6 illustrates an example front-projection, horizontal-parallax display system using multiple projectors and a light field display as in FIG. 4 or FIG. 5;

FIG. 7 illustrates the light reflection pattern of an example front-projection, horizontal-parallax display system using a light field display as in FIG. 4 or FIG. 5; and

FIG. 8 illustrates a flowchart for fabricating a light field display for use in a glasses-free, continuous 3D front-projection display.

### DETAILED DESCRIPTION

A front-projection field display is disclosed to display continuous 3D light fields without the need for specialized viewing glasses or additional optical components. A light field display, as generally described herein, is a display capable of receiving and displaying light fields, which represent the amount of light traveling in every direction through every point in space.

In various embodiments, the front-projection light field display includes a horizontal retro-reflective display screen and a vertical diffuser. A retro-reflective display screen, as generally described herein, is a display capable of reflecting incident light back to its source with minimum scattering. A diffuser, also as generally described herein, is a surface that diffuses (i.e., spreads out) or scatters incident light into a range of angles.

The combination of the horizontal retro-reflective display screen and the vertical diffuser in a light field display enables the formation of continuous 3D light fields with horizontal parallax without the use of any additional optical components and without significant Moiré patterns, ghosting or other distortions commonly attributed to other light field displays. To create the continuous 3D effects, images displayed on the light field display vary in a concerted fashion when viewed from different horizontal directions to enable all viewers in a contiguous viewing region to perceive perspective-correct imagery.

As described in more detail herein below, the horizontal retro-reflective display screen may be composed of a sheet of a given material, such as, for example, metal (e.g., stainless steel, brushed stainless steel, or aluminum, etc.), glass, or a suitable plastic (e.g., polyoxymethylene, polycarbonate) or other transparent material. The horizontal retro-reflective display screen has a microstructured surface that may be coated with a reflective material such as a thin layer (e.g., ˜<1 μm) of mirror-finish aluminum or other reflective metal (e.g., silver). The microstructured surface has an array of narrowly-spaced, ninety-degree microstructures or ridges such that, when illuminated with incident light, it retro-reflects the light in the X-Z (horizontal) plane and reflects it in a mirror-like fashion in the Y-Z (vertical) plane.

As further described is more detail herein below, a diffuser is joined to a surface relative to the microstuctured surface (e.g., the same or the opposite surface) of the retro-reflective display screen. The diffuser is a vertical diffuser with a scattering angle of nearly zero (e.g., smaller than one degree) in the horizontal direction and a relatively broad angle (e.g., larger than forty degrees) in the vertical direction. The diffuser is composed of a microstructured sheet made of a transparent material (e.g., plastic, glass or composite/hybrid substrates). In one embodiment, the microstructures in the vertical diffuser are randomly-patterned (i.e., have a randomly shaped depth profile) and narrowly-spaced. The spacings and depths of the microstructures in the vertical diffuser are very small and at most 10 μm, such as, for example, depths ranging randomly in the order of 1-5 μm.

It is appreciated that, in the following description, numerous specific details are set forth to provide a thorough understanding of the embodiments. However, it is appreciated that the embodiments may be practiced without limitation to these specific details. In other instances, well known methods and structures may not be described in detail to avoid unnecessarily obscuring the description of the embodiments. Also, the embodiments may be used in combination with each other.

Reference in the specification to “an embodiment.” “an example” or similar language means that a particular feature, structure, or characteristic described in connection with the embodiment or example is included in at least that one example, but not necessarily in other examples. The various instances of the phrase “in one embodiment” or similar phrases in various places in the specification are not necessarily all referring to the same embodiment.

Referring now to FIG. 1, an example of a horizontal retro-reflective display screen for use with a front-projection display system is illustrated. Horizontal retro-reflective display screen 100 consists of a sheet of a given material, such as, for example, metal (e.g., stainless steel, brushed stainless steel, aluminum, etc.), glass, or a suitable plastic (e.g., polyoxymethylene, polycarbonate) or other transparent material. The horizontal retro-reflective display screen 100 has a microstructured surface 105 that may be coated with a reflective material such as a thin layer (e.g., ˜<1 μm) of mirror-finish aluminum or other reflective metal (e.g., silver). The coating is used when the horizontal retro-reflective display screen 100 is made of a transparent material and is optional when the horizontal retro-reflective display screen 100 is made of a metal.

The microstructured surface 105 has an array of narrowly spaced microstructures or ridges 110 that are ninety-degrees apart. In one embodiment, the center-to-center spacing of the microstructures may range from 100-200 μm. The ninety-degree angle enables incident light to retro-reflect in the X-Z (horizontal) plane and reflect it back to viewers in a mirror-like fashion in the Y-Z (vertical) plane.

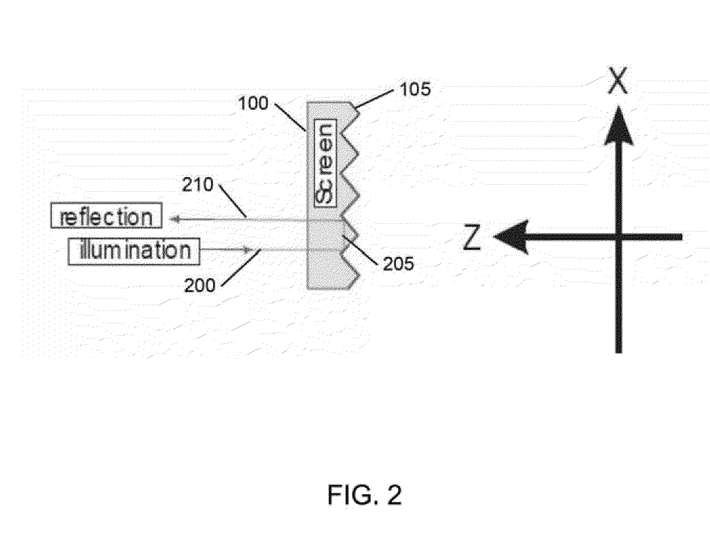

An example reflection pattern of light incident into the horizontal retro-reflective display screen 100 is illustrated in FIG. 2. Example incident light ray 200 comes into the horizontal retro-reflective display screen 100 and is first retro-reflected within the microstructured surface 105 in the X-Z plane (205). Because of the mirror finish of the microstructured surface 105, the retro-reflective light 205 is reflected back to viewers in the light ray 210 in the Y-Z plane.

It is appreciated that the retro-reflective display screen 100 is in effect a horizontal-only retro-reflective display screen as incident light is retro-reflected in the X-Z (horizontal) plane and reflected back to viewers in the Y-Z (vertical) plane. To achieve horizontal-parallax-only continuous 3D images to viewers, a vertical diffuser is joined to a surface relative to the microstructures surface 105 (e.g., the same or the opposite surface) in the horizontal retro-reflective display screen 100,, as described is more detail herein below.

Referring now to FIG. 3, an example of a vertical diffuser for use with the horizontal retro-reflective display screen of FIG. 1 is illustrated. Diffuser 300 contains a series of microstructures or grooves extending throughout one of its surfaces and is composed of a microstructures sheet made of a transparent material (e.g., plastic, glass or composite/hybrid substrates). The microstructures form a random pattern, as illustrated by the depth profile 305, which shows the random depth of each randomly-shaped microstructure in the diffuser 300. Each microstructure in the diffuser 300 has a different depth. In one embodiment, the center-center spacing of the microstructures and their depths are very small and at most 10 μm, such as, for example, depths ranging randomly in the order of 1-5 μm.

It is appreciated that the randomly-patterned, narrowly-spaced microstructured diffuser 300 has a nearly zero (e.g., smaller than one degree) scattering angle in the horizontal direction and a broad (e.g., at least approximately forty degrees) scattering angle in the vertical direction. This is evident with the reflected light distribution 310, which shows a broad light spread in the vertical direction and a very narrow cone angle (ideally zero) in the horizontal direction when the diffuser 300 is illuminated with a laser. It is also appreciated that the horizontal scattering angle can be tailored by varying the length of the microstructures or the shape of the microstructures (e.g., by using sinusoidal microstructures). Additionally, it is further appreciated that the randomly-patterned, narrowly-spaced microstructures significantly reduce any Moiré pattern, ghosting, or other distortion commonly attributed to other diffusers used in other light field displays.

Referring now to FIG. 4, an example light field display using the horizontal retro-reflective display screen of FIG. 1 and the vertical diffuser of FIG. 3 is described. For illustration purposes only, FIG. 4 shows cross sectional views for the vertical diffuser and the horizontal retro-reflector that are perpendicular to each other. Light field display 400 has a microstructure surface 405 in the horizontal retro-reflective display screen 410 opposite the microstructures 415 in the vertical diffuser 420. The microstructures in the microstructured surface 405 and the microstructures 415 are perpendicular to each other. Light 425 coming into the light field display 400 is first incident into the vertical diffuser 420 and retro-reflected back to viewers from the horizontal retro-reflective display screen 410. This results in the incident light 425 getting reflected and fanned out broadly in the Y-Z (vertical) plane and narrowly in the X-Z (horizontal) plane. In this embodiment, the vertical diffuser 420 is joined to the surface opposite the microstructure surface 405 in the horizontal retro-reflective display screen 410. The joining may be done by, for example, laminating the diffuser 420 into the horizontal retro-reflective display screen 410.

It is appreciated that laminating the vertical diffuser 420 onto the horizontal retro-reflective display screen 410 enables light fields to be displayed with only horizontal parallax, as the vertical diffuser 420 has a nearly zero scattering angle in the horizontal direction and a broad angle in the vertical direction. It is also appreciated that the combination of the horizontal retro-reflective display screen 410 and the vertical diffuser 420 to form the light field display 400 enables the formation of horizontal-only continuous 3D light fields without any additional optical components.

It is further appreciated that this combination significantly reduces Moiré patterns, ghosting and other distortions present in other currently available light field displays. The reduction in distortion is a result of the angular distribution of light scattered by the vertical diffuser 420 and the retro-reflective capability of the horizontal retro-reflective display screen 410, as well as the specific shape of the microstructures in the horizontal retro-reflective display screen 420 (i.e., narrowly-spaced, randomly-patterned microstructures) and in the vertical diffuser 420 (i.e., narrowly-spaced, randomly-patterned microstructures).

Another example of a light field display using the horizontal retro-reflective display screen of FIG. 1 and the vertical diffuser of FIG. 3 is illustrated in FIG. 5. For illustration purposes only, FIG. 5 shows cross sectional views of the vertical diffuser and the horizontal retro-reflector that are perpendicular to each other. Light field display 500 has a microstructured surface 505 in the horizontal retro-reflective display screen 510 opposite the microstructures 515 on the vertical diffuser 520. The microstructures in the microstructured surface 505 and the microstructures 515 are perpendicular to each other. Light 525 coming into the light field display 500 is first incident into the vertical diffuser 520 and retro-reflected back to viewers from the horizontal retro-reflective display screen 510. The incident light is reflected and fanned out broadly in the Y-Z (vertical) plane and narrowly in the X-Z (horizontal) plane

In this embodiment, the vertical diffuser 520 is joined to the same surface as the microstructured surface 505 in the horizontal retro-reflective display screen 510. The joining may be done by, for example, attaching the diffuser 520 into the horizontal retro-reflective display screen 510 with a transparent glue, clamping the diffuser 520 into the horizontal retro-reflective display screen 510, or using a thermal adhesion process, among others. An optional gap (not shown) may be inserted between the microstructured surface 505 ins the horizontal retro-reflective display screen 510.

It is appreciated that joining the vertical diffuser 520 onto the horizontal retro-reflective display screen 510 enables light fields to be displayed with only horizontal parallax, as the vertical diffuser 520 has a nearly zero scattering angle in the horizontal direction and a broad angle in the vertical direction. It is also appreciated that the combination of the horizontal retro-reflective display screen 510 and the vertical diffuser 520 to form the light field display 500 enables the formation of horizontal-only continuous 3D light fields without any additional optical components.

It is further appreciated that this combination significantly reduces Moiré patterns, ghosting and other distortions present in other currently available light field displays. The reduction in distortion is a result of the angular distribution of light scattered by the vertical diffuser 520 and the retro-reflective capability of the horizontal retro-reflective display screen 510, as well as the specific shape of the microstructures in the horizontal retro-reflective display screen 510 (i.e., narrowly-spaced, ninety-degree microstructures) and in the vertical diffuser 520 (i.e., narrowly-spaced, randomly-patterned microstructures).

FIG. 6 illustrates an example front-projection, horizontal-parallax 3D light-field display system using multiple projectors and a display screen as in FIG. 4 or FIG. 5. Front-projection display system 600 has an array of projectors and a light field display screen 610. The light field display screen 610 is formed of a horizontal retro-reflective screen 615 and a vertical diffuser 620. The retro-reflective screen 615 has a microstructured surface with narrowly-spaced, ninety-degree microstructures as described above with reference to FIG. 1. The vertical diffuser 620 has randomly-patterned microstructures that generate a nearly zero horizontal scattering angle and a large vertical scattering angle, as described above with reference to FIG. 3.

Each projector in the projector array 605 projects a slightly different perspective view image of a scene or motion picture onto the light field display 610. The images projected by each of the projectors onto the light field display 610 are reflected back to viewers 625a-f to provide continuous, 3D images to the viewers without requiring the use of special viewing glasses and without any significant Moiré patterns, ghosting or other distortions. It is appreciated that the angle of separation between the projectors in the projector array 605 may be equally matched to avoid darkband effects between the images from the projectors.

It is appreciated that the viewers 625a-f of light field display 610 may be of different heights (e.g., children and adult viewers alike) and located at different positions relative to the light field display 600. The viewers 625a-f may change their position at any time and still perceive good quality, continuous 3D images without requiring special viewing glasses and without significant ghosting or other distortions.

Referring now to FIG. 7, a schematic diagram of the light reflection pattern in an example front-projection, horizontal-parallax light-field display system using a display screen as in FIG. 4 or FIG. 5 is illustrated. Display system 700 is an example of a vertical cross sectional view of a front-projection light-field display system. The display system 700 consists of the projector array 705, now shown as if a single projector 705, and a light field display 710, with the projector array 705 placed in front of the light field display screen 710. Light field display screen 710 is formed of a horizontal retro-reflective display screen (e.g., horizontal retro-reflective display screen 100 in FIG. 1) and a vertical diffuser (e.g., vertical diffuser 300 in FIG. 3), such as, for example, in the light field display screen 400 shown in FIG. 4 or in the light field display screen 500 of FIG. 5.

Viewers 715a-c having different heights and at different positions face the light field display 710 to experience glasses-free, continuous 3D images projected from projector 705. Because the viewers 715a-c may have different heights, the incident light 720 coming from projector 705 needs to be reflected back with light rays 725 that can reach any viewer at any position and height. Doing so requires that the light rays 725 be broadly distributed by the light field display 710 screen in the vertical direction. On the other hand, the light field display screen 710 scatters incident light from one of the projectors in array 705 into a narrow horizontal angular distribution such that the reflected illumination is observed by only one of the eyes of a binocular viewer. Having a vertical diffuser in light field display screen 720 with a nearly zero scattering angle in the horizontal direction and a large angle in the vertical direction enables the viewers 715a-c to experience the desired continuous 3D images without any Moiré patterns, ghosting or other distortions.

It is appreciated that the front-projection display system 700 is shown for illustration purposes only. Other display systems (e.g., multi-projector systems) may also include the light field display described herein (e.g., light field display screen 400 shown in FIG. 4 or light field display screen 500 shown in FIG. 5) to achieve the desired continuous 3D effect.

Referring now to FIG. 8, a flowchart for fabricating a display screen for use in a glasses-free, continuous 3D front-projection, horizontal-parallax light-field display system is described. First, a horizontal retro-reflective display screen having a microstructure surface with narrowly-spaced, ninety-degree ridges is fabricated (800). The microstructure surface of narrowly-spaced, ninety-degree microstructures, when illuminated with incident light, retro-reflects the light in the X-Z (horizontal) plane and reflects it back to viewers in a mirror-like fashion in the Y-Z (vertical) plane.

In one embodiment, the horizontal retro-reflective display screen is composed of a sheet of a given material, such as, for example, metal (e.g., stainless steel, brushed stainless steel, aluminum, etc,), glass, or a suitable plastic (e.g., polyoxymethylene, polycarbonate) or other transparent material. As described above with reference to FIG. 1, the microstructured surface may be coated with a reflective material (805) such as a thin layer (e.g., ˜−1 μm) of mirror-finish aluminum or other reflective metal (e.g., silver). The coating is used when the horizontal retro-reflective display screen 100 is made of a transparent material and is optional when the horizontal retro-reflective display screen 100 is made of a metal.

Next, a vertical diffuser is fabricated (810). The vertical diffuser has a scattering angle of nearly zero (e.g., smaller than one degree) in the horizontal direction and a relatively large angle (e.g., larger than forty degrees) in the vertical direction. The vertical diffuser is composed of a microstructured sheet made of a transparent material (e.g., plastic, glass or composite/hybrid substrates). The microstructured sheet has randomly-patterned and narrowly-spaced microstructures, as described above with reference to FIG. 3. In one embodiment, the spacings and depths of the microstructures in the vertical diffuser are at most 10 μm, such as, for example, depths ranging randomly in the order in the order of 1-5 μm.

Lastly, the vertical diffuser is joined to the horizontal retro-reflective display screen to form a light field display (815). In doing so, the microstructures in the horizontal retro-reflective display and the microstructures in the vertical diffuser an perpendicular to each other. The joining may be achieved by lamination (as in FIG. 4) or by attaching, clamping, or using thermal adhesion (as in FIG. 5). The light field display can be used in a front-projection system with a single or multiple projectors to provide good quality, continuous 3D imagers to viewers without requiring the use of special viewing glasses and without any significant Moiré patterns, ghosting or other distortions.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A light field display screen for generating continuous 3D images, the light field display screen comprising:
a retro-reflective display screen having a microstructured surface with an array of narrowly-spaced, ninety-degree microstructures; and
a diffuser having a series of narrowly-spaced, randomly-patterned microstructures.

2. The light field display screen of claim 1, wherein the retro-reflective display screen comprises a horizontal retro-reflective display screen.

3. The light field display screen of claim 1, wherein the diffuser comprises a vertical diffuser with a horizontal scattering angle of nearly zero and a vertical scattering angle of at least forty degrees.

4. The light field display screen of claim 1, wherein the microstructured surface in the retro-reflective display screen is coated with a reflective material to produce a mirror finish.

5. The light field display screen of claim 1, wherein the diffuser is laminated to a surface opposite the microstructured surface in the retro-reflective display screen.

6. The light field display screen of claim 1, wherein the diffuser is joined to the microstructured surface of the retro-reflective display screen.

7. The light field display screen of claim 1, wherein the retro-reflective display screen is made of a metal.

8. The light field display screen of claim 1, wherein the retro-reflective display screen is made of a transparent material.

9. The light field display screen of claim 1, wherein the diffuser is made of a transparent material.

10. The light field display screen of claim 1, wherein the narrowly-spaced, ninety-degree microstructures in the microstructured surface in the retro-reflective display screen are perpendicular to the narrowly-spaced, randomly-patterned microstructures in the diffuser.

11. A front-projection display system, comprising:
at least one projector; and
a light field display screen formed of a horizontal retro-reflective display screen having a microstructured surface with an array of narrowly-spaced, ninety-degree microstructures and a vertical diffuser having a series of narrowly-spaced, randomly-patterned microstructures.

12. The front-projection display system of claim 10, wherein the vertical diffuser has a horizontal scattering angle of nearly zero and a vertical scattering angle of at least forty degrees.

13. The front-projection display system of claim 11, wherein the microstructured surface in the horizontal retro-reflective display screen is coated with a reflective material to produce a mirror finish.

14. The front-projection display system of claim 11, wherein the vertical diffuser is laminated to a surface opposite the microstructured surface in the horizontal retro-reflective display screen.

15. The front-projection display system of claim 11, wherein the vertical diffuser is joined to the microstructured surface of the horizontal retro-reflective display screen.

16. A method of fabricating a light field display for generating continuous 3D images, the method comprising:
fabricating a horizontal retro-reflective display screen having a microstructured surface with an array of narrowly-spaced, ninety-degree microstructures;
fabricating a vertical diffuser having a series of narrowly-spaced, randomly-patterned microstructures; and
joining the vertical diffuser to the horizontal retro-reflective display screen.

17. The method of claim 16, further comprising coating the microstructured surface of the horizontal retro-reflective display screen with a reflective material to produce a mirror finish.

18. The method of claim 16, wherein the vertical diffuser comprises a horizontal scattering angle of nearly zero and a vertical scattering angle of at least forty degrees.

19. The method of claim 16, wherein joining the vertical diffuser to the horizontal retro-reflective display screen comprises laminating the vertical diffuser to a surface opposite the microstructured surface in the horizontal retro-reflective display screen.

20. The method of claim 16, wherein joining the vertical diffuser to the horizontal retro-reflective display screen comprises attaching the vertical diffuser to the microstructured surface in the horizontal retro-reflective display screen.
